(19) United States
(12) Patent Application Publication
(10) Pub. No.: US 2009/0122138 A1
(43) Pub. Date: May 14, 2009

(54) Scattered Light Diaphragm For Reducing The Scattered Light Incident Into A Camera

(76) Inventors: Stefan Bischoff, Leonberg (DE); Gunther Schaaf, Kornwestheim (DE)

Correspondence Address: KENYON & KENYON LLP, ONE BROADWAY, NEW YORK, NY, 10004, US

(21) Appl. No.: 11/792,472

(22) PCT Filed: Nov. 11, 2005
(86) PCT No.: PCT/EP05/55922

§ 371 Date: Feb. 20, 2008

(30) Foreign Application Priority Data
Dec. 6, 2004 (DE) 10 2004 058 683.7

(51) Int. Cl. H04N 7/18

(52) U.S. Cl. 348/148; 348/164; 348/E07.085

(57) ABSTRACT

A camera module having a scattered light diaphragm installed in front of a lens of the camera module. The scattered light diaphragm is in contact with the inside of a windshield, the scattered light diaphragm having a structure on its inside for reducing the incident light. The structure for reducing the incident scattered light includes at least one secondary ramp-shaped structure which is oriented perpendicular to the optical axis of the camera system.

### FIELD OF THE INVENTION

In motor vehicles, night view systems having an infrared camera installed at the level of the rear view mirror, directly behind the windshield, are used for displaying and processing the instantaneous driving situation. Infrared cameras used in this way have a scattered light diaphragm for reducing the disturbing effect of scattered light. The scattered light diaphragm used reduces the effect of the scattered light incident into the camera.

### BACKGROUND INFORMATION

German Patent Publication No. DE 102 37 607 describes a camera system for motor vehicles. The camera system includes a camera situated in the interior of the vehicle behind the windshield. The camera is installed in a bracket attached to the inside of the windshield. According to this approach, the bracket forms a cover which encloses the space between windshield 10 and a camera lens in a light-tight and dust-tight manner, the camera being situated at the end of the cover facing the windshield. The cover has a light inlet window enclosed by a peripheral edge, and its peripheral edge is in contact with the windshield in such a way that the cover is sealed by the windshield in the area of the light inlet window.

German Patent Publication No. DE 102 52 446 describes a camera system which is suitable for a portable electric device in particular. The camera system includes an electronic camera element for receiving light emitted by a light source. It is furthermore provided with an optical element for refracting the light emitted by the light source, the optical element being situated between the electronic camera element and the light source. Furthermore, an absorption element is provided, which is situated between the electronic camera element and the light source to control the intensity of the light incident onto the camera element. According to the approach known from German Patent Publication No. DE 102 52 446, the absorption element is manufactured from a phototropic material.

Previous scattered light diaphragms used in motor vehicles have had a stepped structure on the inside to shutter out reflected lateral light. Reflected lateral light is reflected back outward by the structure formed on the inside of the scattered light diaphragm. The scattered light is considerably reduced by optimizing the parameters regarding the height of the steps of the stepped structure, the step widths, and the 15, angles between horizontal and vertical surfaces. Furthermore, the inside of the scattered light diaphragm is black-colored for maximum light absorption.

However, unfavorable situations also arise in which the incident scattered light from above, for example, sunlight, or the light from street lights, enters the camera. In this case, further reflection takes place on the windshield, which guides all or part of the light to the camera. The width and height of the stepped structure formed on the inside of the scattered light diaphragm have no influence on this effect. However, optimizing the angles of the steps for reducing the scattered light from above would considerably weaken the primary effect of achieving the reduction of the scattered light incident from the front, which is undesirable.

This situation could be remedied by creating “light traps.” Such light traps may be represented by small depressions in which light is reflected back and forth until it loses intensity by absorption on the surfaces. This, however, requires complex manufacturing associated with disproportionately high costs for producing such small hole-shaped structures on the individual steps of the stepped structure provided on the inside of the scattered light diaphragm. Furthermore, it is currently almost impossible to prevent, at a reasonable cost, the edges from being considerably rounded when applying paint. It has been found that, when applying paint to the primary structure within the scattered light diaphragm, the edges are significantly rounded during drying due to the flow of the paint, and the thus obtained rounding radii have the same geometric order of magnitude as the light traps. This would modify the original structure containing the light traps to such an extent that the desired function would no longer be achievable.

### SUMMARY OF THE INVENTION

It is provided according to the present invention that the stepped structure inside the scattered light diaphragm be modified by applying an additional, secondary stepped structure on the existing stepped structure having a sequence of steps in the direction of the optical axis (X axis). On the secondary stepped structure, the sequence of steps of the additional stepped structure runs perpendicular to the optical axis (i.e., parallel to the Y axis). Alternatively, the secondary stepped structure may be formed by small, consecutive, oblique ramps, which are superimposed on the existing steps of the existing primary stepped structure.

The light incident from above, such as sunlight for example, or the light from a street light, having an angle of incidence which almost coincides with the direction of the Z axis and whose Y component is equal to 0, and which was previously reflected back again with Y=0, may thus now be impressed by a Y component different from 0.¹ Most of such scattered light incident from above is thus guided past the lens.

The advantage of the approach provided by the present invention is primarily that only a slight modification of the system proven in use is necessary. The advantage of proper reduction in the scattered light using the first stepped structure formed on the inside of the scattered light diaphragm regarding the scattered light incident from the front (X direction) is fully preserved. By adding a structure that is similar in principle regarding geometry and dimensions, i.e., a secondary stepped structure, it may be ensured that the manufacturing process for producing the stepped structures on the inside of the scattered light diaphragm may remain unchanged in principle.

Furthermore, using the approach provided according to the present invention, the manufacture of “light traps,” which may be formed on the inside of the scattered light diaphragm only at a disproportionately high cost, may be omitted.

### BRIEF DESCRIPTION OF THE DRAWINGS

The present invention is elucidated in more detail with reference to the drawing.

FIG. 1 schematically shows the initial situation having a scattered light diaphragm in front of a camera.

FIG. 2 shows a cross section of a scattered light diaphragm known from the related art.

FIG. 3 shows the light incident from above onto the scattered light diaphragm according to FIG. 1.

FIG. 4 shows the reflection relationships of the light incident from above and the scattered light diaphragm according to FIG. 2.

FIG. 5 shows a secondary stepped structure according to the present invention superimposed on an existing stepped structure.

FIG. 6 shows the optical path of the light incident from above onto a primary stepped structure on the inside of the scattered light diaphragm.

FIG. 7 shows the optical path of the light incident from above onto the inside of a scattered light diaphragm, which has, in addition to the primary stepped structure, an additional, secondary stepped structure proposed according to the present invention.

FIG. 8 shows a primary structure having angles different from 0° and 90°.

FIG. 9 shows a stepped primary structure which includes more than two elements and has a chamfered edge;

FIG. 10 shows a stepped primary structure in which the steps are provided with angles different from 0° and 90° and a chamfered edge, and

FIG. 11 shows a ramp-shaped secondary structure, which is superimposed on the stepped primary structure and has an asymmetric design with respect to the optical axis.

### DETAILED DESCRIPTION

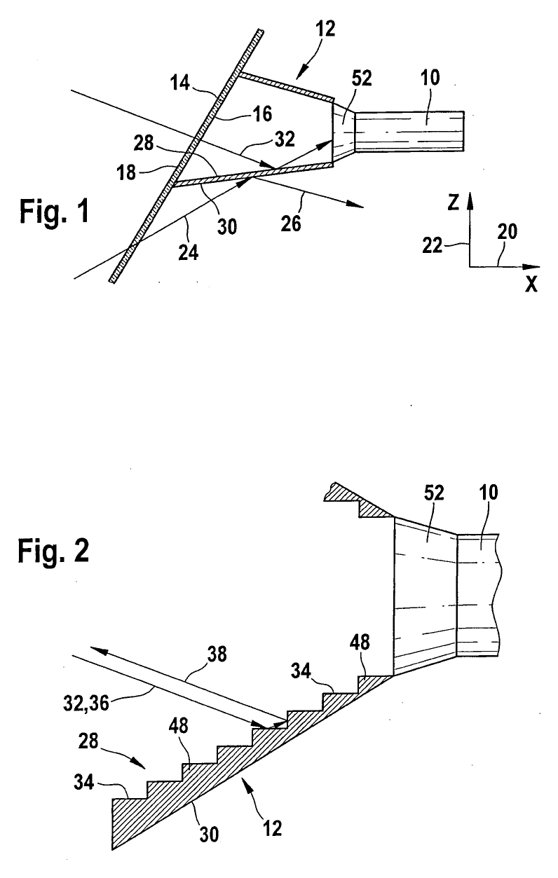

FIG. 1 schematically shows the presently prevailing optical paths of a camera installed on the inside of a windshield.

FIG. 1 shows that a scattered light diaphragm 12 is installed in front of a camera module 10. Scattered light diaphragm 12 is in contact with an inside 16 of an oblique windshield 14. The outside of windshield 14 is labeled with the reference numeral 18. In the coordinate system according to FIG. 1, the X axis is labeled with the reference numeral 20. X axis 20 represents the optical axis of camera 10. Reference numeral 22 identifies the Z axis, i.e., the vertical axis in this case. Scattered light diaphragm 12 includes an outside 30 and an inside 28. The light directly incident on outside 30 of scattered light diaphragm 12 is shuttered out, which is represented by arrow 26.

Indirect light 32 passing through windshield 14 from outside 18 to inside 16 is reflected on inside 28 of scattered light diaphragm 12 and enters a lens 52 of camera module 10.

FIG. 2 shows a primary stepped structure formed on the inside of the scattered light diaphragm.

In FIG. 2, the inside of scattered light diaphragm 12 is shown on an enlarged scale. Scattered light diaphragm 12, known from the related art, includes a primary stepped structure 34, which is formed on inside 28 of scattered light diaphragm 12. Outside 30 of scattered light diaphragm 12 extends, according to the inclination of scattered light diaphragm 12, to bridge the distance between lens 52 of camera module 10 and inside 16 (not shown in FIG. 2) of windshield 14.

Primary stepped structure 34 includes individual steps 48. A light beam 32, 36 incident into scattered light diaphragm 12 is reflected by the top of a step 48 to the front of another step of primary stepped structure 34 adjacent to step 48 and emitted by this primary stepped structure as reflected light 38. Light beam 38 thus represents reflected indirect light 32, 36, which does not enter lens 52 of camera module 10.

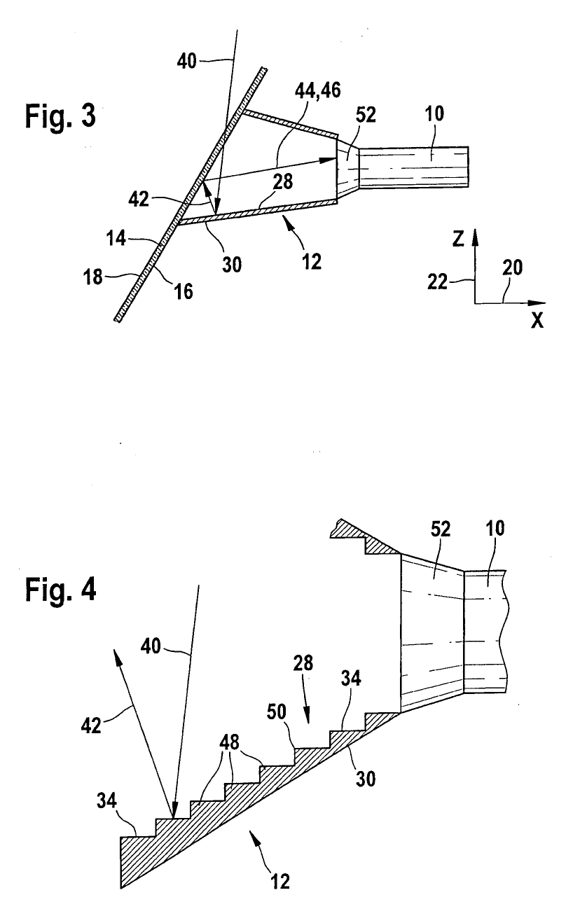

FIG. 3 shows the optical path of light incident from above, which enters scattered light diaphragm 12 and is reflected into camera module 10.

Light 40 incident from above according to FIG. 3 refers to beams of sunlight or the light from street lights or other light sources, for example. Light 40 incident from above reaches inside 28 of scattered light diaphragm 12. According to FIG. 2, inside 28 of scattered light diaphragm 12 is provided with a primary stepped structure 34, which is however not shown in FIG. 3 for greater clarity. Light 40 incident from above is reflected, according to arrow 42, on inside 28 of scattered light diaphragm 12 having primary stepped structure 34, to inside 16 of windshield 14. Reflected light 42 is guided, according to optical path 44, 46, from inside 16 of windshield 14 into lens 52 installed in front of camera module 10.

FIG. 4 shows the optical path of light 40 incident from above, which enters scattered light diaphragm 12, on an enlarged scale. It is apparent from FIG. 4 that light 40 incident from above is guided from steps 48 of primary stepped structure 34 according to arrow 42 to the inside of the windshield, which is not shown in FIG. 4. In the case of an unfavorable angle of incidence of light 40 incident from above, primary stepped structure 34 is ineffective; according to the optical path shown in FIG. 3, light 40 incident from above is guided, after reflection on inside 16 of windshield 14, directly into lens 52 installed in front of camera module 10 and thus directly enters this lens, greatly interfering with the picture-taking quality of camera module 10. For the sake of completeness, it should be pointed out that each step 48 has a sharp edge 50. Scattered light diaphragm 12 is a U-shaped structure, whose open side is covered by windshield 14. The primary ramp-shaped structures are formed on the two opposite legs of the U-shaped scattered light diaphragm; also on the bottom of the U-shaped profiled structure.

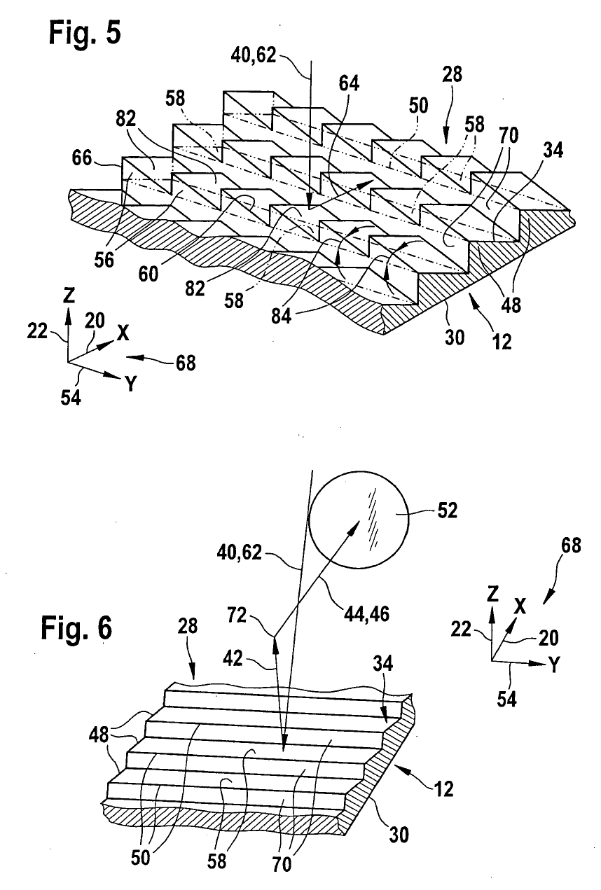

A scattered light diaphragm according to the present invention is shown in FIG. 5.

In FIG. 5, scattered light diaphragm 12 is reproduced only partially. Scattered light diaphragm 12 includes primary stepped structure 34 on inside 28. It has individual steps 48, each of which has a flat face 58 and a front face 70. Furthermore, steps 48 have an edge 50, at which flat face 58 and front face 70 meet. Primary stepped structure 34 is located on inside 28 of scattered light diaphragm 12, while outside 30 is essentially straight; see FIGS. 2 and 4.

According to FIG. 5, a secondary ramp-shaped structure 56 is applied to flat face 58 of a step 48. Secondary ramp-shaped structure 56 includes individual elevations having a ramp-shaped design. The individual ramp-shaped elevations include a deflecting surface 82, inclined with respect to flat face 58 of primary stepped structure 34; this deflecting surface is inclined with respect to flat face 58 of step 48 by an angle 84. Deflecting surface 82 is delimited by a front face 66. According to FIG. 5, secondary ramp-shaped structure 56, superimposed on primary stepped structure 34, is situated in such a way that deflecting surfaces 82 are inclined with respect to the outside of scattered light diaphragm 12. Secondary ramp-shaped structure 56 includes a plurality of ramp-shaped elevations according to the width of scattered light diaphragm 12.

Reference is made to coordinate system 68 for the spatial orientation, which shows the orientations of X axis 20, corresponding to the optical axis, Z axis 22, and Y axis 54. According to this figure, secondary ramp-shaped structure 56 extends essentially along Y axis 54. Deflecting surfaces 82 of secondary ramp-shaped structure 56 are inclined by an angle 84 with respect to Z axis 22. According to the approach proposed by the present invention, the sequence of the individual ramp-shaped elevations runs perpendicular to X axis 20, i.e., parallel to Y axis 54.

Light 40, 62 incident from above hits deflecting surfaces 82 of secondary ramp-shaped structure 56 and is reflected according to angle of inclination 84 as indicated by arrow 64. In the approach proposed according to the present invention, a component extending in the direction of Y axis 54 is impressed on reflected light 64. Light 64 reflected by secondary ramp-shaped structure 56 is reflected onto a lateral face of scattered light diaphragm 12, and absorbed there, and/or reflected onto the opposite lateral face of the scattered light diaphragm, etc.

Instead of the plurality of ramp-shaped elevations shown in FIG. 5, an evenly rising stepped structure having individual small shoulders may also be formed on plane 58 of individual steps 48. It is furthermore possible to design deflecting surfaces 82 at an angle of inclination 84 with respect to flat surface 58 that is different from the one shown in FIG. 5. In the approach according to the present invention, a primary stepped structure 34 provided on scattered light diaphragm 12, which is essentially designed as a 2D structure in the X and Z directions and then displaced in parallel in the Y direction, becomes a three-dimensional structure by placing an additional stepped or ramp-shaped structure 56 on each step 48 of primary stepped structure 34. Individual ramp-shaped elevations, formed by deflecting surface 82 of front face 66 and angle of inclination 84, provide new structure parameters such as inclination and height of the individual ramp-shaped elevations and number of ramps, for example; scattered light 40, 62 incident from above may be substantially reduced by optimizing these parameters. The ramp-shaped elevations of secondary ramp-shaped structure 56 include vertical faces 66 and deflecting surfaces 82 oriented at an angle of inclination 84, providing new structural parameters, for example, regarding angle of inclination 84 of deflecting surface 82 and regarding the height of front face 66, as well as the number of ramp-shaped elevations per step 48.

In another, advantageous embodiment, secondary ramp-shaped structure 56 may be designed to form the center of each step 48 of primary stepped structure 34 axially symmetrically with respect to optical axis 20, which coincides with the X axis. This means that not all ramp-shaped elevations of a secondary ramp-shaped structure 56 on flat face 48 point to one side of scattered light diaphragm 12, but each points to the closer edge of scattered light diaphragm 12.

FIG. 6 shows the optical path of light incident from above into a camera lens.

From FIG. 6 it is apparent that light 40, 62 incident approximately vertically from above is reflected on flat face 58 of step 48. Furthermore, steps 48 are subdivided into flat face 58 and front face 70 by edges 50. Light 40, 42 incident on flat surface 58 is reflected according to reflected light 42 on a point of incidence 72 on the inside of a windshield 14 not shown in FIG. 6, and directly enters lens 52, which is installed in front of camera module 10, as reflected light 44, 62. Primary stepped structure 34 is worked into inside 28 of scattered light diaphragm 12.

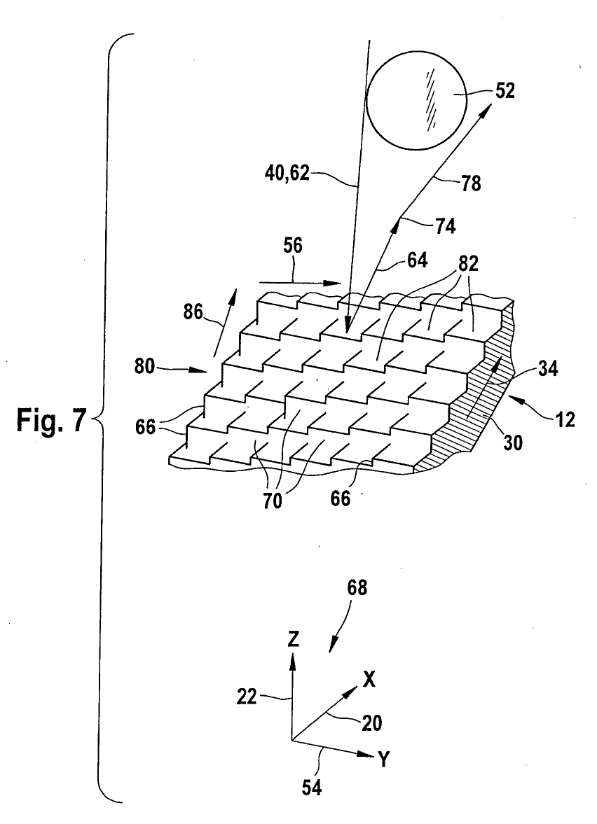

FIG. 7 shows the secondary ramp-shaped structure applied to primary stepped structure 34 formed on the inside of the scattered light diaphragm.

Although in FIG. 5 the proposed secondary ramp-shaped structure 36 is applied to only one flat face 58 of step 48, it is possible to apply secondary ramp-shaped structure 56 to each face 58 of each step 48 of primary stepped structure 34. FIG. 7 shows another secondary ramp-shaped structure 80 and a third secondary ramp-shaped structure 86, each of which is applied to flat surfaces 58 of individual steps 48 of primary stepped structure 34. The front faces of the individual ramp-shaped elevations are identified with reference numeral 66, while the deflecting surfaces are identified by reference numeral 82.

Reference is made to coordinate system 68 for illustrating the optical path achievable via the approach according to the present invention. The Z axis is labeled 22, the X axis is labeled 20, and the Y axis is labeled 54. X axis 20 coincides with the optical axis of camera lens 52, i.e., of camera module 10.

Due to the inclination of individual deflecting surfaces 82 of the ramp-shaped elevations of ramp-shaped secondary structure 56, a beam 40, 62 incident vertically from above is reflected at an inclination on deflecting surface 82. Reflected light 64 hits inside 16 of windshield 14 at a modified point of incidence 74 and is reflected according to reference numeral 78 as a deflected beam past camera lens 52. Light 40, 62 incident from above is thus not able to impair the picture-taking quality of camera lens 52, i.e., camera module 10 behind it, because beams 40, 62 incident from above are guided past camera lens 52 as beams 78.

The approach according to the present invention makes it possible to optimize a conventional scattered light diaphragm 12, without modifying the manufacturing process selected for producing the primary stepped structure 34. Only a slight modification of the previously mentioned system is necessary, which ensures the advantage of proper reduction of the scattered light coming from X direction 22. By modifying primary stepped structure 34 on inside 28 of scattered light diaphragm 12, the advantageous properties of the known approach may be preserved. By adding a similar structure regarding shape and dimensions, the previously used, proven manufacturing process may continue to be used in principle.

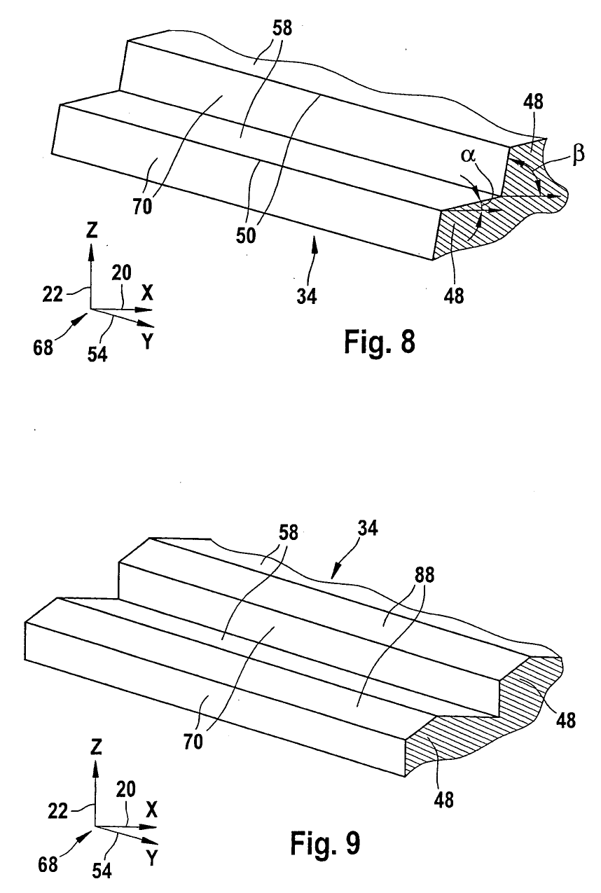

FIG. 8 shows a primary structure having a stepped design. Primary structure 34 includes vertical front faces 70 and flat faces 58, which meet along an edge 50. Front faces 70 and flat faces 58 form steps 48. In the embodiment of the primary structure depicted in FIG. 8, flat faces 58 run at an angle of inclination α, which is different from 0, i.e., flat faces 58 are inclined either upward or downward with respect to edges 50 of individual steps 58. Individual steps 48 are oriented at an angle of inclination β, which is different from 90°, with respect to front faces 70 of these individual steps. This means that front faces 70 of individual steps 48 form an angle in the range between 80° and 110° with the vertical.

FIG. 9 shows a possible further configuration of the primary structure.

According to the embodiment depicted in FIG. 9, primary structure 34 includes both flat faces 58 and front faces 70, which however do not meet along a common edge 50, but are connected by an oblique surface 88. Oblique surface 88 depicted in FIG. 9 replaces edge 50 according to edge 50 of particular step 48 shown in FIGS. 4, 6, and 8. In the embodiment of FIG. 9, the angle at which chamfered surface 88 is oriented with respect to flat face 58 of step 48 is on the order of magnitude between 20° and 30°.

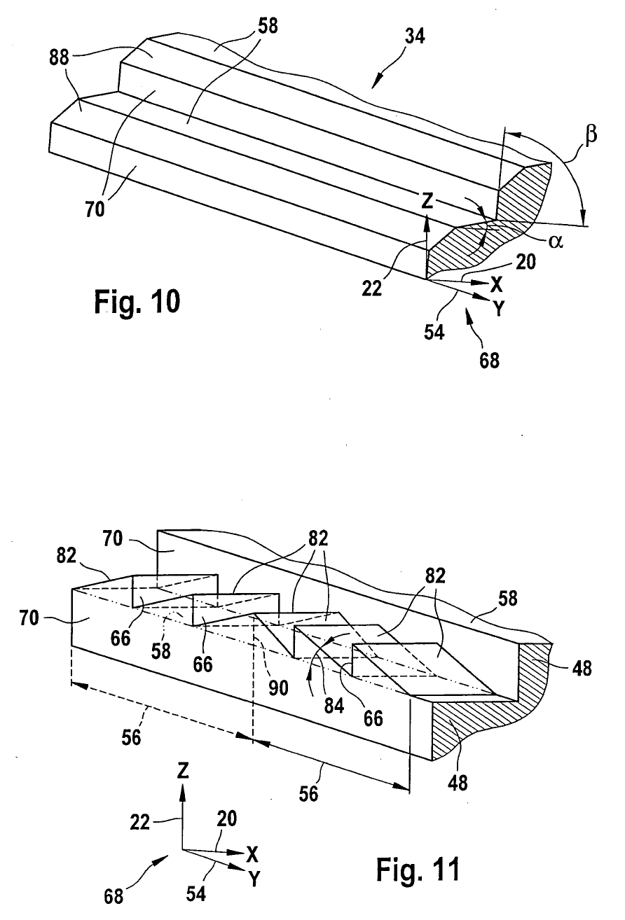

FIG. 10 shows another embodiment option of a primary structure having a stepped design.

Primary structure 34 according to FIG. 10 represents a combination of the features of the embodiments according to FIGS. 8 and 9. In the embodiment of FIG. 10, flat face 58 is connected to front face 70 of a step 48 by an oblique surface 88. The angle of inclination at which oblique surface 88 is oriented with respect to flat face 58 is advantageously on the order of magnitude between 20° and 30°.

FIG. 10 shows that flat face 58 is inclined to X axis 20 by an angle α. According to FIG. 10, flat face 58 is inclined upward by a few degrees.

Furthermore, it is apparent from FIG. 10 that front face 70 is inclined with respect to the vertical by an angle θ not equal to 90°.

FIG. 11 shows another embodiment of primary structure 34, on which two secondary ramp-shaped structures 56 of opposite orientations are superimposed. Each of the two secondary ramp-shaped structures 56 extending opposite one another has a plurality of ramp-shaped elevations, each of which includes deflecting surface 82. Deflecting surfaces 82 are oriented in such a way that reflected light 64 deflected by them hits the two legs of U-shaped scattered light diaphragm 12, extending, at a distance from one another, in the vertical direction. Each of deflecting surfaces 82 of secondary ramp-shaped structure 56 is inclined by angle of inclination 85 and includes a front face 66. In FIG. 11, secondary ramp-shaped structures 56, oriented opposite one another, are situated on a flat face 58 of a step 48 of primary structure 34. Of course, it is possible to situate secondary ramp-shaped structures 56 adjacent to one another along a central axis 90 according to FIG. 11 on flat faces 58 inclined at an angle α in order to influence the reflection of the light incident into scattered light diaphragm 12. In FIG. 11, front faces 70 of steps 48 are oriented vertically; however, they may also be oriented at an angle of inclination β to the vertical, as explained in more detail above in connection with FIGS. 9 and 10, in order to improve the reflection properties.

What is claimed is:

1-17. (canceled)

18. A camera system for a motor vehicle, comprising:
a camera module; and
a scattered light diaphragm that includes a structure on an inside of the scattered light diaphragm that reduces an incident scattered light, wherein the structure for reducing the incident scattered light includes at least one secondary ramp-shaped structure that is oriented perpendicular to an optical axis of the camera system.

19. The camera system as recited in claim 18, wherein the structure for reducing the incident scattered light has a stepped design.

20. The camera system as recited in claim 18, wherein the secondary ramp-shaped structure has a plurality of ramp-shaped elevations, each of which includes a deflecting surface.

21. The camera system as recited in claim 20, wherein the deflecting surfaces are situated at an angle of inclination with respect to the steps of a primary structure for reducing the incident scattered light.

22. The camera system as recited in claim 18, wherein the secondary ramp-shaped structure deflects the light incident from above to points of incidence from which the light incident from above is deflected past the camera system.

23. The camera system as recited in claim 18, wherein the secondary ramp-shaped structure is axially symmetrical with respect to the optical axis of the camera system.

24. The camera system as recited in claim 23, wherein the deflecting surfaces are oriented with respect to the optical axis to point toward the outside of the scattered light diaphragm.

25. The camera system as recited in claim 23, wherein the deflecting surfaces have front faces with respect to the optical axis, whose extension in the direction of the Z axis increases with increased distance from the optical axis.

26. The camera system as recited in claim 18, wherein, viewed in the direction of the optical axis, a plurality of secondary ramp-shaped structures are situated on the steps of the primary stepped structure toward a lens of the camera module.

27. The camera system as recited in claim 18, wherein the primary, stepped structure and the secondary ramp-shaped structure are black-colored.

28. The camera system as recited in claim 20, wherein, viewed in the direction of the Y axis, the ramp-shaped elevations of the secondary ramp-shaped structure are adjacent.

29. The camera system as recited in claim 28, wherein the front faces of the ramp-shaped elevations are adjacent at bases of inclined deflecting surfaces.

30. The camera system as recited in claim 19, wherein the structure for reducing the incident scattered light has steps whose adjacent flat faces has front faces, the flat faces being inclined by an angle of inclination α with respect to the horizontal and the front faces being inclined by an angle of inclination β with respect to the vertical.

31. The camera system as recited in claim 19, wherein the primary structure has steps, whose flat faces and front faces are connected by a chamfered surface.

32. The camera system as recited in claim 19, wherein the primary structure has steps each having a flat face and a front face, the flat faces being situated at an angle of inclination α with respect to the horizontal, and the front faces being inclined by an angle of inclination β with respect to the vertical, and the flat faces and the front faces of each step of the primary structure being connected by a chamfered surface.

33. The camera system as recited in claim 19, wherein the primary structure includes a plurality of steps, on whose flat faces at least two secondary ramp-shaped structures are situated whose deflecting surfaces are oriented opposite one another.

34. The camera system as recited in claim 18, wherein the scattered light diaphragm is in contact with an inside of a windshield.
